(19) United States
(12) Patent Application Publication
(10) Pub. No.: US 2005/0266830 A1
(43) Pub. Date: Dec. 1, 2005

(54) Method for notifying a wireless unit that a wireline unit is in an off-hook state

(76) Inventors: Deborah Lewandowski Barclay, Winfield, IL (US); David S. Benco, Winfield, IL (US); Sanjeev Mahajan, Naperville, IL (US); Thomas Lee McRoberts, Naperville, IL (US); Raymond Leroy Ruggerio, Glenview, IL (US)

Correspondence Address: Lucent Technologies Inc.;Docket Administrator - Room 3J-219, 101 Crawfords Corner Road, Holmdel, NJ, 07733-3030, US

(21) Appl. No.: 10/856,722

(22) Filed: May 28, 2004

(51) Int. Cl. H04M 3/16

(52) U.S. Cl. 455/412.1; 370/311

(57) ABSTRACT

The present invention provides a method for notifying a wireless unit that a wireline unit is in an off-hook state. A central office switch determines that a wireline phone is in an off-hook state. The central office switch determines if the receiver off-hook monitoring feature is active for the wireline phone. If so, the communication system sends a message to a wireless unit associated with the wireline phone to alert a user of the wireless unit that the wireline unit is off-hook. When the wireline unit goes back on-hook, the communication system sends an on-hook message to the wireless unit to indicate that the wireline phone has returned to the on-hook state.

### FIELD OF THE INVENTION

The present invention relates generally to communication systems, and more particularly to wireline communication units that are left in an off-hook state.

### BACKGROUND OF THE INVENTION

Wireline telephone networks, such as the public switched telephone network (PSTN), provide subscribers with the ability to communication with other users. The wireline telephone network provides access to users, typically by providing a subscriber line to a premises, such as a home or business. The subscriber line normally includes multiple extensions that can be connected to the subscriber line. The extensions allow multiple CPEs to have access to the communication network using the same communication line. This allows multiple CPEs to be involved in a call.

One downside to having multiple CPEs connected to the PSTN is that one CPE can affect the operability of other CPEs on the same subscriber line. For example, wireline subscribers may inadvertently leave one of their phones off-hook. When a phone is left off-hook, no incoming calls can be completed and the line appears “dead” (i.e., no dial tone) for outgoing call attempts. Phones may be left in this state because of a previous call, such as when the call is answered with one extension but a different extension phone is used for the duration of the call. Other times a receiver may be accidentally knocked off the base unit, resulting in the CPE being off-hook.

Since the subscriber line remains inoperable while a phone connected to it is off-hook, it is desirable to know when a phone has been left in an off-hook state. One such example is in the case of an elderly subscriber who might drop the phone or knock the phone off the base unit during a medical emergency. A friend or family member would like to know of the off-hook condition in this case in order to check on the elderly subscriber.

An additional problem caused by off-hook wireline units is the continual busy signal that is received by any phones calling the off-hook wireline unit. A caller has to call back, usually on regular intervals, to try to communicate with the wireline phone, and has no way of knowing when the wireline phone exits the off-hook state by returning to an on-hook state.

Therefore, a need exists for a method that allows a user to know when a wireline phone has been left in an off-hook state. Further, a need exists for a method that alerts a caller that a wireline phone that was off-hook has returned to the on-hook state.

### BRIEF SUMMARY OF THE INVENTION

The present invention provides a method for notifying a wireless unit that a wireline unit has been left in an off-hook state. The communication network will also notify the wireless unit when the wireline unit goes back on-hook.

A central office switch detects that a wireline unit has been left in an off-hook state. Upon detection, the switch alerts a user at the premises of the wireline phone that the wireline phone has been left off-hook, such as by playing an announcement and also by playing a loud tone over the wireline phone, commonly referred to as a “howler tone.”

The switch then determines if a receiver off-hook notification service is available for the off-hook wireline phone. If the service is active, the switch notifies a wireless unit associated with the off-hook wireline phone that the wireline phone is off-hook. In an exemplary embodiment of the present invention, the switch utilizes SMS (Short Message Service) to notify the wireless unit. Alternately, the switch utilizes email or instant messaging to notify the wireless unit that the wireline unit is off-hook. The message sent to the wireless unit preferably includes the directory number of the wireline phone and the time of day that the off-hook condition occurred.

In accordance with an exemplary embodiment of the present invention, the switch monitors the wireline phone to determine when the wireline phone goes back on-hook. When the wireline phone goes back on-hook, the switch sends a message, preferably in the same manner as the off-hook message was sent, to the wireless phone. The message alerts the wireless unit user that the phone is now back on-hook. The message preferably includes the directory number of the wireline phone and the time that the wireline phone went back on-hook. This can assure the wireless unit user that a person located at the location of the wireline phone is not in any physical danger, and can also be a signal to the wireless unit user that the wireline phone can most likely be called without receiving a busy signal.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for notifying a wireless unit that a wireline unit is in an off-hook state in accordance with an exemplary embodiment of the present invention.

### DETAILED DESCRIPTION OF THE INVENTION

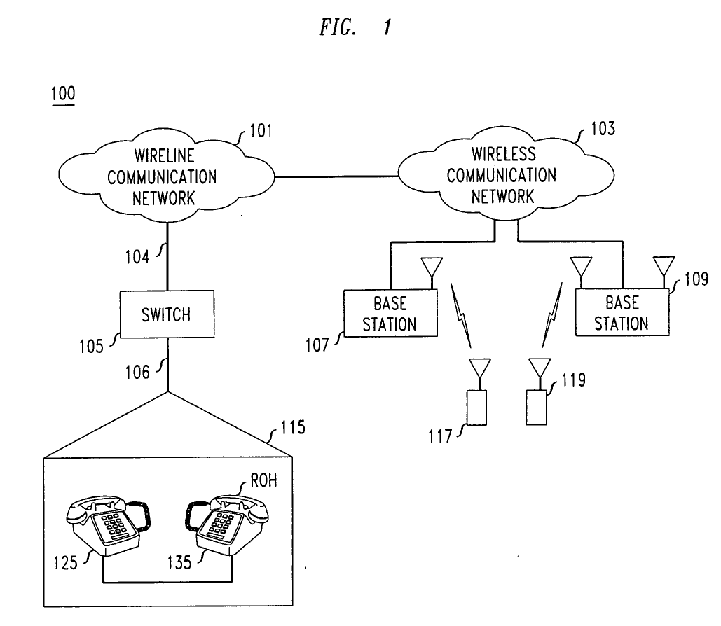

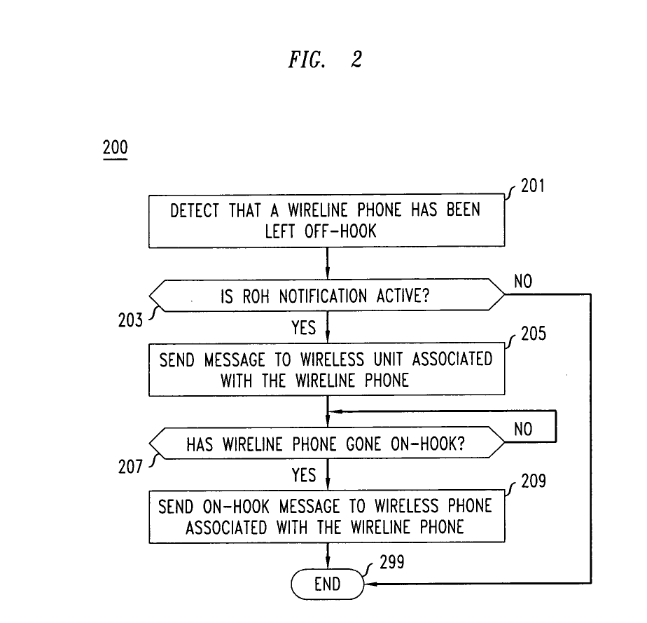

The present invention can be better understood with reference to FIGS. 1 and 2. FIG. 1 depicts a communication system 100 that includes a wireline communication network 101, a wireless communication network 103, central office switch 105, and base stations 107 and 109.

Wireline communication network 101 is preferably a public switched telephone network (PSTN). Wireline communication network 101 provides communication to a plurality of wireline users, only two of which, CPE 125 and CPE 135, are depicted for clarity.

Switch 105 is connected to wireline communication network 101 via line 104. In a preferred embodiment, there are a plurality of switches connected to wireline communication network 101, and each of the plurality of switches provide access for a plurality of CPEs to wireline communication network 101. In an exemplary embodiment of the present invention, switch 105 is a 5E/SS SWITCH provided by LUCENT TECHNOLOGIES INC.

Premises 105 is typically a house or other building, such as an office building, school, church, or any other building that is connected to PSTN 101 by switch 105. In an exemplary premises, a single communication line 106 runs to premises 115 from switch 105. For CPEs connected to a phone line, the CPEs are able to participate in the same call. If one of the CPEs is left off-hook after a call ends, however, not only is the off-hook CPE unable to make or receive a call, but all other CPEs connected to the same phone line are prevented from making or receiving calls. Premises 115 is depicted with two customer premises equipment, CPE 125 and CPE 135.

Wireless communication network 103 can utilize any wireless protocol, including but not limited to analog, such as AMPS, TACS and NMT, or digital, such as GSM, TDMA, CDMA, GPRS, EDGE, IS-95, IS-95B, HDR, UMTS, CDMA2000, 3GPP, and 3GPP2. Base stations 107 and 109 communicate with wireless communication network 103 and communication over the air with wireless units 117 and 119, respectively. Although only two base stations and two wireless units are depicted in FIG. 1 for clarity, it should be understood that wireless communication network 103 typically includes a plurality of base stations, and each base station services a plurality of wireless units.

FIG. 2 depicts a flowchart 200 of a method for notifying a wireless unit that a wireline unit is in an off-hook state in accordance with an exemplary embodiment of the present invention.

In an exemplary embodiment of the present invention, a central office switch detects (201) that a wireline phone has been left in an off-hook state. The central office switch monitors every subscriber phone for the off-hook state. In an off-hook state, a wireline phone closes the circuit, which causes current to flow. The voltage measured across a POTS (Plain Old Telephone Service) phone drops from its normal 48 volts DC to approximately 3 to 9 volts.

If no action is detected by the central office switch after a predetermined amount of time, the central office switch plays a prerecorded announcement that asks the subscriber to either hang up the wireline phone or dial the operator for assistance. If the subscriber does not hang up the wireline phone, such as by returning the wireline phone to an on-hook state, the communication network generates a Receiver Off Hook (ROH) tone, also known as a howler tone. In an exemplary embodiment, the ROH tone utilizes four different frequencies. In the United States, the frequencies are 1400 Hz, 2060 Hz, 2450 Hz, and 2600 Hz. When the ROH tone is played, the central office switch considers the wireline phone to be in the off-hook, or ROH, state.

In an exemplary embodiment of the present invention, the communication system determines (203) if ROH notification is active for the off-hook wireline phone. ROH notification can be offered to subscribers as a feature that can be subscribed to. In such a case, the central office switch checks a field in the subscriber record to determine if the subscriber has subscribed to the ROH notification service. In an exemplary embodiment, this step happens after the completion of the playing of the howler tone. If the subscriber has not subscribed to the ROH notification service, the processing ends (299), and typical processing occurs. If ROH notification is active, processing continues to steps 205, 207, and 209.

Communication system sends (205) a message to a wireless unit associated with the wireline phone that is off-hook. In an exemplary embodiment, the directory number of the wireless unit is stored in the subscriber record of the wireline unit. In an exemplary embodiment, the switch sends a message to the mobile wireless unit's SMS service center. In alternate exemplary embodiments, the central office switch sends an email or an IM (Instant Message) to the wireless unit. The message preferably includes the wireline directory number and the time of day that the off-hook condition occurred. The SMS service center relays the message to the selected wireless unit.

The communication system determines (207) if the CPE has gone on-hook by monitoring the circuit to the POTS phone. When the closed loop is opened and the line voltage returns to its normal 48 volts DC, the line is now in the on-hook state.

When the CPE goes back on-hook, the switch sends (209) an on-hook message to the wireless phone associated with the wireline phone. The communication system preferably sends the on-hook message in a similar manner as the off-hook message was sent. In the preferred embodiment, the central office switch sends a message to the wireless unit's SMS service center indicating that the off-hook condition has cleared by the wireline unit going on-hook. In alternate exemplary embodiments, the central office switch sends an email or an IM to the wireless unit. The message preferably includes the wireline directory number and the time of day that the wireline unit went back on-hook.

The present invention thereby provides a method for notifying a wireless unit that a wireline unit is in an off-hook state. By alerting a wireless unit that a wireline unit is off-hook, appropriate response can occur. For example, the communication system can contact someone located at or near the premises of the wireline phone and have that person check into the situation, or a user of the wireless unit user can investigate the situation. This can be especially important when an elderly person or the like is in a premises with an off-hook wireline unit, which could indicate that the elderly person has experienced some sort of physical trauma.

The present invention also provides notification to a wireless unit of a previously off-hook phone that has returned to an on-hook state. This allows the wireless unit to establish communication with the wireline unit in an expeditious manner, but without having to continuously dial the wireline phone.

While this invention has been described in terms of certain examples thereof, it is not intended that it be limited to the above description, but rather only to the extent set forth in the claims that follow.

1. A method for notifying a wireless unit that a wireline unit is in an off-hook state, the method comprising:
determining that a wireline phone is in an off-hook state;
determining if receiver off-hook monitoring is active for the wireline phone; and
if receiver off-hook monitoring is active for the wireline phone, sending a message to a wireless unit associated with the wireline phone.

2. A method for notifying a wireless unit that a wireline unit is in an off-hook state in accordance with claim 1, wherein the step of sending a message to a wireless unit comprises sending an SMS message to the wireless unit.

3. A method for notifying a wireless unit that a wireline unit is in an off-hook state in accordance with claim 1, wherein the step of sending a message to a wireless unit comprises sending an email message to the wireless unit.

4. A method for notifying a wireless unit that a wireline unit is in an off-hook state in accordance with claim 1, wherein the step of sending a message to a wireless unit comprises sending an Instant Message to the wireless unit.

5. A method for notifying a wireless unit that a wireline unit is in an off-hook state in accordance with claim 1, wherein the message includes the directory number of the wireline phone.

6. A method for notifying a wireless unit that a wireline unit is in an off-hook state in accordance with claim 1, wherein the message includes the time of day that the wireline phone entered the off-hook state.

7. A method for notifying a wireless unit that a wireline unit is in an off-hook state in accordance with claim 1, the method further comprising the step of determining that the wireline phone has returned to an on-hook state.

8. A method for notifying a wireless unit that a wireline unit is in an off-hook state in accordance with claim 7, the method further comprising the step of sending an on-hook message to the wireless unit associated with the wireline phone, wherein the on-hook message indicates that the wireline phone has returned to an on-hook state.

9. A method for notifying a wireless unit that a wireline unit is in an off-hook state in accordance with claim 8, wherein the step of sending an on-hook message to the wireless unit comprises sending an SMS message to the wireless unit.

10. A method for notifying a wireless unit that a wireline unit is in an off-hook state in accordance with claim 8, wherein the step of sending an on-hook message to the wireless unit comprises sending an email message to the wireless unit.

11. A method for notifying a wireless unit that a wireline unit is in an off-hook state in accordance with claim 8, wherein the step of sending an on-hook message to the wireless unit comprises sending an Instant Message to the wireless unit.

12. A method for notifying a wireless unit that a wireline unit is in an off-hook state in accordance with claim 8, wherein the on-hook message includes the directory number of the wireline phone.

13. A method for notifying a wireless unit that a wireline unit is in an off-hook state in accordance with claim 8, wherein the on-hook message includes the time of day that the wireline phone went on-hook.

14. A method for notifying a wireless unit that a wireline unit is in an off-hook state in accordance with claim 1, wherein the step of determining if receiver off-hook monitoring is active for the wireline phone comprises checking a subscriber record of the wireline unit.

15. A method for notifying a wireless unit that a wireline unit is in an off-hook state in accordance with claim 1, further comprising the step of retrieving the directory number of the wireless unit from the subscriber record of the wireline unit.
